(19) United States
(12) Patent Application Publication
(10) Pub. No.: US 2002/0109921 A1
(43) Pub. Date: Aug. 15, 2002

(54) Kaleidoscope

(76) Inventor: Chiu-Chin Liu, Tao-Yuan Hsien (TW)

Correspondence Address: Chiu-Chin LIu, P.O. Box No.6-57, Chung-Ho City, Taipei Hsien, 235, TW

(21) Appl. No.: 09/887,359

(22) Filed: Jun. 25, 2001

(30) Foreign Application Priority Data
Feb. 14, 2001 (TW) 090202181

(51) Int. Cl. G02B 27/08

(52) U.S. Cl. 359/616

(57) ABSTRACT

A kaleidoscope comprises of members including a convex lens, a lens seat, a view lens, an inner bush cylinder, etc. mounted together inside a shell body of the kaleidoscope composed by a front cylinder body and a rear cylinder body; observing forwards from the view window of the rear cylinder body, the figured pattern mirrored on the surface of every plane facet on the convex lens from the surface of the view lens can be seen and displayed in the forms of a multiplicity of figured patterns; optionally, rotating the front cylinder body can control every surface of the plane facets to rotate axially around the axle center on the convex lens, and rotating the rear cylinder body can control the figured pattern inside every plane facet to spin synchronously so as to provide a kaleidoscope with specially interesting effect.

### BACKGROUND OF THE INVENTION

1) Field of the Invention

The invention herein relates to a kaleidoscope, more especially, a kaleidoscope designed to utilize a convex lens composed by multiple plane facets as the condensing lens to be adapted with the view lens mounted with figured pattern on the surface and to utilize an inner bush cylinder and a lens seat disposed between the rotatable front cylindrical body and the rotatable rear cylindrical body to produce the special effect of displaying an interesting multiplicity of patterns and to comply with the innovative structure of a kaleidoscope of a new generation.

2) Description of the Prior Art

Most of the conventional kaleidoscope consists of a set of prismatic mirrors mounted inside a long cylinder body as the basic structure. The prismatic mirrors are utilized as the reflective mirrors for the figured patterns. Although the structure of this kind of kaleidoscope is very simple, only the cylinder body can be rotated in operation to change the displaying effect of the figured patterns; therefore, relatively, less expected interest will be produced. Furthermore, some of the kaleidoscopes are designed to contain water, oil and colorful particles inside an enclosed container to display the figured patterns; however, in operation, same as the mentioned kaleidoscope with prismatic mirrors, only the cylinder body can be rotated to change the displaying effect of the patterns thus the operational interest is substantially reduced.

In view of the foregoing problems to be solved, the inventor of the invention herein enthusiastically researched and improved the design for many times, finally culminated a kaleidoscope of the new generation. More especially, the front cylinder body and the rear cylinder body of the kaleidoscope of the invention herein can be controlled and rotated, or reversely rotated at the same time to achieve the displaying effect of changing patterns with unique interest.

Therefore, the primary objective of the invention herein is to provide an improved kaleidoscope structure designed by utilizing a convex lens with multiple plane facets as the condensing lenses to be adapted with the view lens mounted with figured pattern on the surface and by utilizing an inner bush cylinder and a lens seat disposed between the rotatable front cylinder body and the rotatable rear cylinder body to display the special effect of an interesting multiplicity of patterns for a kaleidoscope of innovation.

### SUMMARY OF THE INVENTION

According to the invention herein mentioned above, the entire kaleidoscope includes at least a convex lens, a lens seat, a view lens and an inner bush cylinder mounted together inside the shell body composed by a front cylinder body and a rear cylinder body, wherein, the convex lens is held by the inner bush cylinder and the front cylinder body and positioned inside the front cylinder body; the view lens is pressed by the lens seat and positioned inside the concave portion of the rear cylinder body; so the front cylinder body or the rear cylinder body of this kaleidoscope can be rotated or reversely rotated at the same time to control the operational effect.

The surface of the convex lens of the said kaleidoscope is composed by multiple plane facets arranged in rows and columns; the surface of the view lens is mounted with colorful figured patterns; therefore, to observe forwards from the view window on the rear cylinder body, the figured patterns mirrored from the surface of the view lens onto every surface of every plane facet on the convex lens can be seen and displayed completely different from the traditional figured patterns.

Optionally, rotating the front cylinder body can control every plane facet to rotate axially around the axle center on the convex lens; rotating the rear cylinder body can control the figured pattern inside every plane facet to spin synchronously; rotating the front cylinder body and the rear cylinder body reversely at the same time can control every rotating figured pattern to rotate axially around the axle center on the convex lens to provide various specially interesting effect.

Another objective of the invention herein is to provide an improved kaleidoscope capable of being operated by increasing the quantity of the view lenses according to the need and mounting with different figured pattern on every view lens to allow the operator to freely select different view lens relative to the convex lens for increasing the variation of the figured patterns.

To enable a further understanding of the features and the innovation of the invention herein, the brief description of the drawings below is followed by the detailed description of the preferred embodiment.

### BRIEF DESCRIPTION OF THE DRAWINGS

FIG. 1 is a pictorial drawing of the kaleidoscope of the invention herein.

FIG. 2 is a pictorial drawing of the kaleidoscope of the invention herein viewed from another angle.

FIG. 3 is an exploded drawing of the members of the kaleidoscope of the invention herein.

FIG. 4 is a cross sectional drawing of the assembled kaleidoscope of the invention herein.

FIG. 5 is an enlarged drawing of the partial FIG. 4.

FIG. 6 is a cross sectional drawing of the exploded members of the kaleidoscope of the invention herein.

FIG. 7 is an isometric drawing of the surface of the convex lens of the kaleidoscope of the invention herein.

FIG. 8 is an isometric drawing of the surface of the view lens of the kaleidoscope of the invention herein.

FIG. 9 is a drawing of the figured patterns observed from the view window of the kaleidoscope.

FIG. 10 is a drawing of the embodiment of rear cylinder body with multiple view windows of the invention herein.

FIG. 11 is a drawing of the embodiment of the rear cylinder body with rotatable view window of the invention herein.

### DETAILED DESCRIPTION OF THE PREFERRED EMBODIMENTS

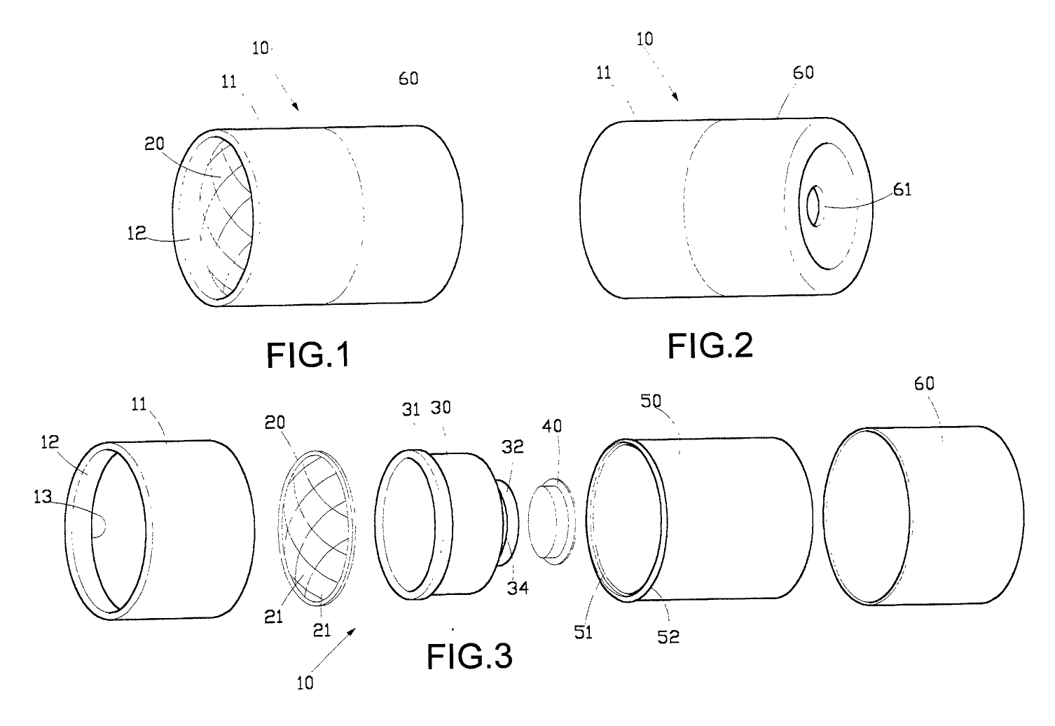

The entire kaleidoscope (10) of the invention herein, as shown in FIGS. 1,2, and 3, comprises of a convex lens (20), a lens seat (30), at least a view lens (40) and an inner bush cylinder (50) mounted together inside the shell body of the kaleidoscope composed by a front cylinder body (11) and a rear cylinder body (60).

As shown in FIGS. 3, 4 and 6, the said front cylinder body (11) is designed in a cylindrical shape with a ring flange (12) mounted on the inner rim on the opening end and a concave ring groove (13) disposed inside the flange (12).

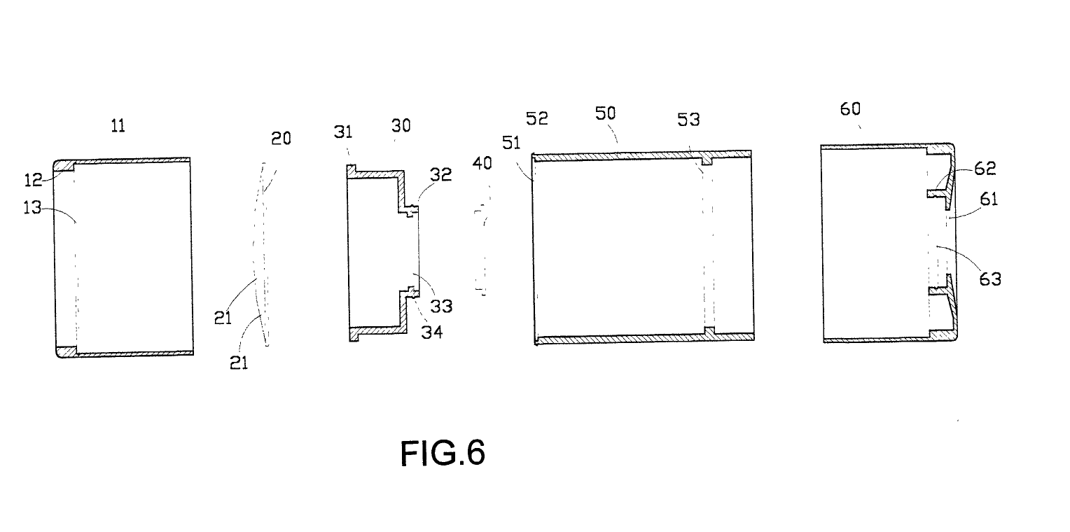

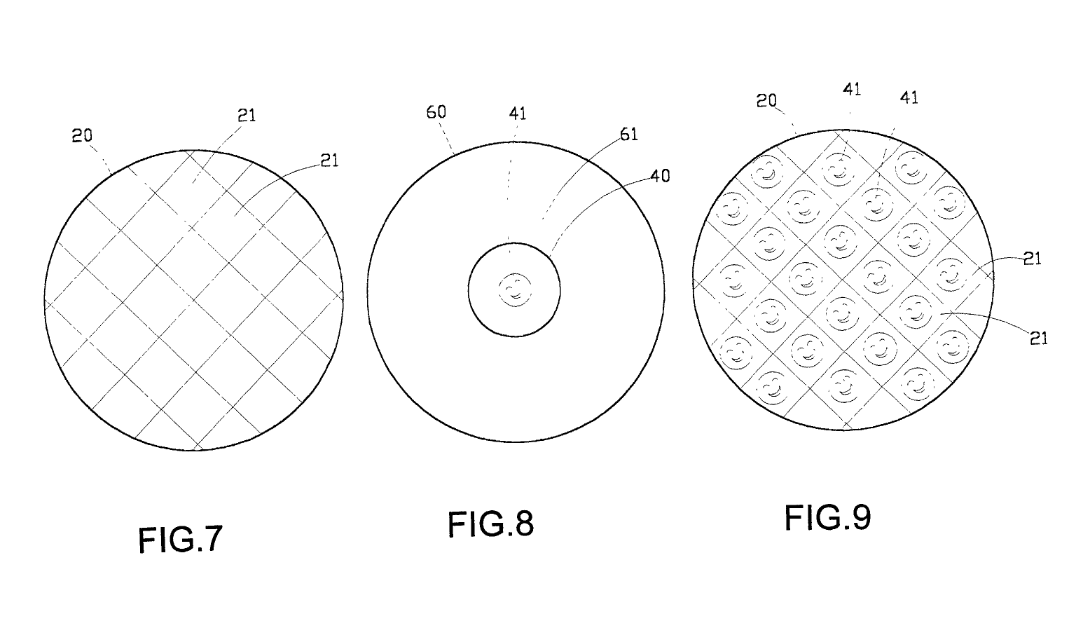

The said convex lens (20) is a transparent lens with multiple plane facets (21) arranged on convex surface of the convex lens (20), as shown in FIG. 7, for facing the light resource and achieving the function of condensing the light The said lens seat (30) is also designed in a cylindrical shape, as shown in FIG. 6 of its cross sectional drawing, with a flange (31) mounted on the outer portion of the front opening end, a projecting portion (32) disposed on the rear side, an inner flange (33) mounted on the inner perimeter of the wall surface inside the projecting portion (32) and an outer flange (34) mounted on outer the perimeter of the wall surface outside the projecting portion (32).

The said view lens (40) is a transparent lens in smaller volume to be just received inside the opening end of the projection portion (32) mounted on the rear side of the lens seat (30) and with colorful figured pattern (41) mounted on the surface as shown in FIGS. 8, 9 and 10.

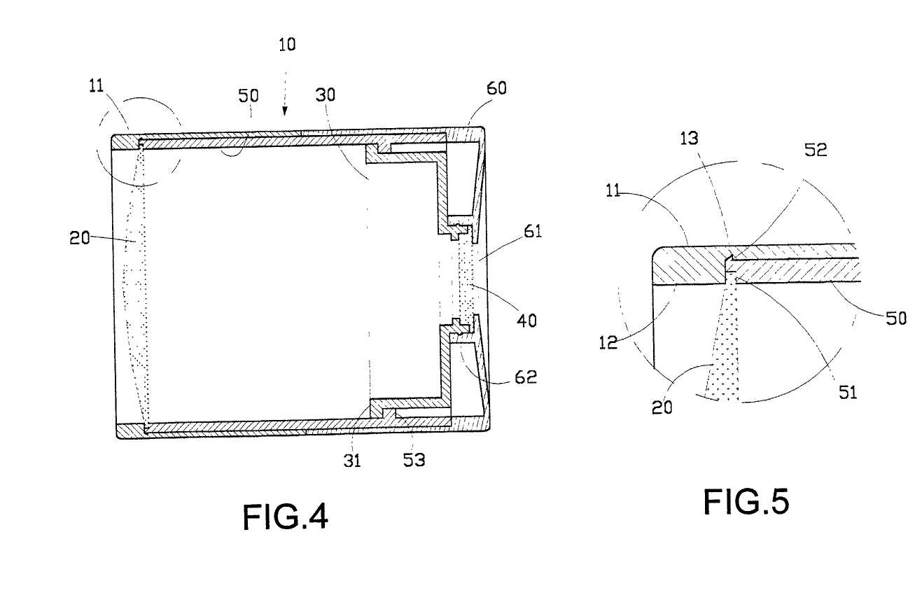

The said inner bush cylinder (50) is in the shape of a cylinder with the cylinder diameter smaller than that of both the front cylinder body (1) and the rear cylinder body (60) to be coaxially received inside the front cylinder body (11) and the rear cylinder body (60) as shown in FIGS. 3, 4 and 6; the inner ring groove (51) mounted on the inner rim on the front opening end of the inner bush cylinder (50) can just receive the said convex lens (20); the outer ring hook (52) mounted on the outer rim on the front opening end can be retained inside the said inner ring groove (13) of the said front cylinder body (11) thus to make the inner bush cylinder (50) connect with the front cylinder body (11) and at the same time, to hold and position the convex lens (20), as shown in FIG. 4 and 5; another inner flange (53) is mounted on the inner wall surface of the inner bush cylinder (50) for just stopping the contact of the flange (31) on the opening end of the said lens seat (30), as shown in FIG. 4.

As shown in FIGS. 3, 4 and 6, both the said rear cylinder body (60) and the front cylinder body (11) are designed in the shape of cylinder with same cylinder diameter to compose the outer shell body of the kaleidoscope (10) together. A view window (61) is mounted on the surface of the rear end surface of he rear cylinder body (60); a concave portion (62) is formed by extending from the inside of the view window (61) toward the inside of the rear cylinder body (60), as shown in FIG. 6; an inner ring groove (63) is concaved on the inner wall surface of the concave portion (62); the concaved space of the concave portion (62) can just receive the projecting portion (32) and the view lens (40) of the said lens seat (30), as shown in FIG. 4; furthermore, the inner ring groove (63) can be just retained to the outer flange (34) on the projecting portion (32) to tightly connect the said lens seat (30) and the rear cylinder body (60), and at the same time, to hold, press and position the view lens (40).

After the assembling of the mentioned members, as shown in the cross sectional drawing in FIG. 4, wherein the convex lens (20) is held and positioned inside the front cylinder body (11) by the inner bush cylinder (50) and the front cylinder body (11); the view lens (40) is pressed by the projecting portion (32) of the lens seat (30) into the concave portion (62) of the rear cylinder body (60) for positioning; between the inner bush cylinder (50) and the lens seat (30), by the stopping contact of the inner flange (53) of the inner bush cylinder (50) to the flange (31) on the opening end of the lend seat (30), every member will be maintained in an inserted status of inter-controlling not easy for loosening; furthermore, rotating the front cylinder body (11) can link the rotating movement of the inner bush cylinder (50) and the convex lens (20); rotating the rear cylinder body (11) can link the rotating movement of the lens seat (30) and the view lens (40).

As shown in FIG. 7 of the structure of the surface of the convex lens (20) and in FIG. 8 of the figured pattern on the surface of the view lens, when the operator observes from the view window (61) of the rear cylinder body (60) to look forwards to the convex lens (20) through the view lens (40), since the figured pattern (41) of the surface of the view lens (40) mirrored onto every plane facet (21), a multiplicity of figured patterns, as shown in FIG. 9, can be seen through the view window (61).

Optionally, the operator can rotate the front cylinder body (11) to control and rotate the convex lens (20) thus to make very plane facet (21) to rotate axially around the axle center on the convex lens (20); therefore, as shown in FIG. 9, the figured patterns (41) one every plane facet (21) will also rotate axially around the axle center on the convex lens (20).

The operator can also rotate the rear cylinder body (60) to control and rotate the view lens (40) thus to make the figured pattern (41) on the view lens (40) to spin; therefore, as shown in FIG. 9, the figured patterns (41) inside every plane facet (21) will spin synchronously.

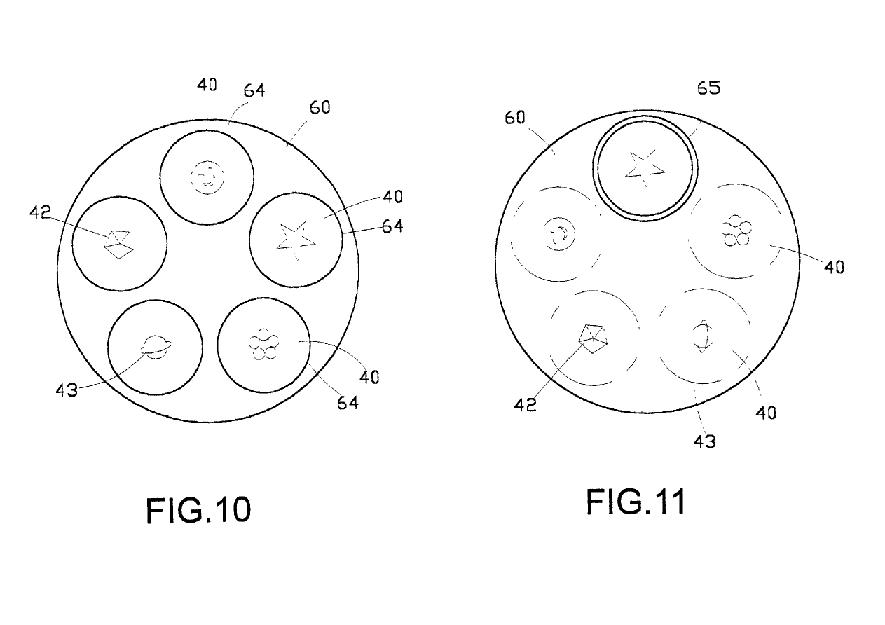

FIGS. 10 and 11 provide the drawings of the embodiment of the rear cylinder body with multiple view lenses and rotatable view lens of the invention herein.

As shown in FIG. 10, multiple view lenses (64) can be mounted on the end surface of the rear cylinder body (60) of the invention herein with a view lens (40) inside every view window (64); different figured patterns (42, 43) can be mounted on the surface on every view lens (40); in this embodiment, the operator can freely select different view window (64) to observe different figured patterns.

As shown in FIG. 11, a single view window (65) can be mounted on the end surface of the rear cylinder body (60) of the invention herein, with multiple view lenses disposed inside the rear cylinder body (60) and with different figured patterns (42, 43) mounted on the surface of every view lens (40); in this embodiment, the operator can rotate the rear cylinder body (60), through the different view lenses (40) displayed by the rotating and moving view window (65) to observe different figured patterns through the different view lenses (40) displayed by the rotating and moving view window (65).

Therefore, the said kaleidoscope of the invention herein is capable of rotating and controlling the front cylinder body or the rear cylinder body, or reversely rotating the front and the rear cylinder bodies at the same time to achieve the displaying effect of the changing patterns with unique operational interest. Furthermore, the design of the invention herein utilizing the convex lens composed by multiple plane facet as the condensing lens to be adapted with the view lens mounted with figured patterns and utilizing an inner bush cylinder and a lens seat disposed between the rotatable front cylinder body and rotatable rear cylinder body to achieve the special effect of displaying interesting patterns is not revealed by any previous product of the similar category and is an invention of innovation.

In practical application, the quantity of the view window and the view lens of the invention herein can be increased according to the need; different figured patterns can also be mounted on every view lens permitting the operator with free selection of different view lens relative to the convex lens for increasing the variety of the figured patterns.

In summation of the foregoing sections, the invention herein can definitely achieve the expected functions and objectives, and be described in detail for those who familiar with this art to practice the embodiment. However, the embodiment mentioned above is only for illustration, any variation with the structure of the same efficiency and any modification not beyond the spirit of the invention herein should belong to the scope of the invention herein.

1. A kaleidoscope comprises of a convex lens, a lens seat, at least a view lens and an inner bush cylinder mounted together inside a shell body of the kaleidoscope composed by a front cylinder body and a rear cylinder body, is characterized in that:
the front cylinder body is designed in a cylindrical shape with ring flange mounted on the inner rim on the opening end and a concave ring groove disposed inside the flange;
the convex lens is a transparent lens with multiple plane facets arranged on the convex surface of the convex lens for facing the light resource and achieving the function of condensing the light;
the lens seat is also designed in a cylindrical shape with a flange mounted on the outer portion of the front opening end, a projecting portion disposed on the rear side, an inner flange mounted on the inner perimeter of the wall surface inside the projecting portion and an outer flange mounted on the outer perimeter of the wall surface outside the projecting portion;
the view lens is a transparent lens to be just received inside the opening end of the projection portion mounted on the rear side of the lens seat and with colorful figured pattern mounted on the surface;
the inner bush cylinder is in the shape of a cylinder with the cylinder diameter smaller than that of both the front cylinder body and the rear cylinder body to be coaxially received inside the front cylinder body and the rear cylinder body; the inner ring groove mounted on the inner rim on the front opening end of the inner bush cylinder can just receive the convex lens; the outer ring hook mounted on the outer rim on the front opening end can be retained inside the inner ring groove of the front cylinder body thus to make the inner bush cylinder connect with the front cylinder body and at the same time, to hold and position the convex lens; another inner flange is mounted on the inner wall surface of the inner bush cylinder for just stopping the contact of the flange on the opening end of the lens seat;
the rear cylinder body and the front cylinder body are both designed in the shape of a cylinder with same cylinder. At least one view window is mounted on the rear end surface of the rear cylinder body; a concave portion is formed by extending from the inside of the view window toward the inside of the rear cylinder body; an inner ring groove is concaved on the inner wall surface of the concave portion; the concaved space of the concave portion can just receive the projecting portion and the view lens of the lens seat; the inner ring groove can be just retained to the outer flange on the projecting portion to tightly connect the lens seat and the rear cylinder body, and at the same time, to hold, press and position the view lens.

2. A kaleidoscope according to claim 1, wherein the convex lens is held and positioned inside the front cylinder body by the inner bush cylinder and the front cylinder body; the view lens is pressed by the projecting portion of the lens seat into the concave portion of the rear cylinder body for positioning; between the inner bush cylinder and the lens seat, by the stopping contact of the inner flange of the inner bush cylinder to the flange on the opening end of the lend seat, every member will be maintained in an inserted status of inter-controlling; rotating the front cylinder body can link the inner bush cylinder and the convex lens; rotating the rear cylinder body can link the rotating movement of the lens seat and the view lens.

3. A kaleidoscope according to claim 1, wherein multiple view lenses can be mounted on the end surface of the rear cylinder body with a view lens inside every view window and different figured pattern disposed on the surface of each view lens.

4. A kaleidoscope according to claim 1, a single view window can be mounted on the end surface of the rear cylinder body, with multiple view lenses mounted inside the rear cylinder body and different figured pattern mounted on the surface of every view lens; rotating the rear cylinder body, different figured patterns will be displayed and observed through different view lenses and the rotating and moving view window.
